(19) United States
(12) Patent Application Publication
(10) Pub. No.: US 2019/0366278 A1
(43) Pub. Date: Dec. 5, 2019

(54) FLUID FLOW CONTROL APPARATUS

(71) Applicant: AIRRAT PTY LTD, Kingscliff (AU)

(72) Inventor: Ian Bradley Nielsen, Kingscliff (AU)

(21) Appl. No.: 16/485,377

(22) PCT Filed: Feb. 9, 2018
(86) PCT No.: PCT/AU2018/050101

§ 371 Date: Aug. 12, 2019

(30) Foreign Application Priority Data
Feb. 13, 2017 (AU) 2017900456

(51) Int. Cl. B01F 3/04; B01F 13/00; B01F 13/02; C02F 3/20

(52) U.S. Cl. CPC B01F 3/0412; B01F 13/0049; B01F 13/0222; B01F 2215/0052; B01F 2003/04134; B01F 2003/04234; C02F 3/20

(57) ABSTRACT

Apparatus for controlling flow of fluid in a fluid body containing a first fluid, the apparatus including: a baffle at least partially submerged in the fluid body, the baffle including: in inlet that in use is coupled to a fluid supply adapted to supply a second fluid; at least one outlet; at least one internal channel extending from the inlet to the at least one outlet to thereby allow second fluid to be expelled from the at least one outlet; and, an outer surface which acts with the at least one outlet to at least partially guide second fluid expelled from the outlet to induce flow within the fluid body and thereby agitate the fluid body.

### CROSS-REFERENCE TO RELATED APPLICATIONS

This application is a National Phase Application of International Application PCT/AU2018/050101, filed Feb. 9, 2018, which claims priority to Australian Patent Application No. 2017900456, filed Feb. 13, 2017, the disclosures of which are incorporated herein by reference in their entirety.

### TECHNICAL FIELD

The present disclosure relates to a fluid flow apparatus for controlling or managing a flow of fluid within a fluid body, for example to assist with agitation or aeration of the fluid, or to reduce fluid flow to promote settling.

### BACKGROUND

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

There are a number of situations in which it can be desirable to agitate a body of water or other fluid, for example to aerate the water, to mix the water with solids or other materials, to induce water currents, for example for the purpose of destratification, or the like. A number of different solutions are known, most of which focus on the use of a pump to pump water.

### SUMMARY

In one aspect of the present disclosure, an apparatus is provided for controlling flow of fluid in a fluid body containing a first fluid. The apparatus includes a baffle that is at least partially submerged in the fluid body. The baffle includes (a) an inlet that, in use, is coupled to a fluid supply adapted to supply a second fluid; (b) at least one outlet; and (c) at least one internal channel extending from the inlet to the at least one outlet to thereby allow the second fluid to be expelled from the at least one outlet. The baffle may also include an outer surface that acts with the at least one outlet to at least partially guide the second fluid expelled from the outlet to induce flow within the fluid body and thereby agitate the fluid body.

In one embodiment, the apparatus includes a platform that, in use, is provided on a surface of the fluid body. The platform includes at least one mooring connector that, in use, is coupled to a mooring to thereby at least partially restrain movement of the platform in use. Also, the baffle may be attached to the platform.

In one embodiment, the platform includes at least one ballast tank that has an inlet and outlet in fluid communication with a ballast cavity to thereby allow ballast fluid to be added to or removed from the ballast tank to thereby adjust a buoyancy of the platform.

In one embodiment, the platform includes a platform body that includes a baffle mounting proximate at a first end of the platform and adapted to pivotally support the baffle.

In one embodiment, the baffle is attached to a mooring connector that, in use, is coupled to a mooring to thereby at least partially restrain movement of the baffle in use.

In one embodiment, a first end of the baffle is attached to a first mooring connector and a second end of the baffle is suspended from a surface body, allowing an angle of the baffle to be adjusted.

In one embodiment, the ballast is used to at least partially submerge the baffle, where the ballast is at least one of attached to and provided in the baffle.

In one embodiment, the baffle is made of an at least partially hollow body.

In one embodiment, the outer surface includes one or more external channels for directing flow of fluid at least part way along a length of the baffle.

In one embodiment, the one or more external channels are defined by a plurality of spaced apart ridges extending along at least part of a length of the outer surface.

In one embodiment, at least one channel includes features to control fluid flow along the at least one channel.

In one embodiment, the features include at least one of: shapes, profiles, surface textures, fluting, rifling, and scalloping.

In one embodiment, different channels include different features to introduce differential flow rates along the channels.

In one embodiment, the baffle includes a plurality of laterally spaced outlets.

In one embodiment, the outlets include an outlet connector adapted to receive at least one of: a nozzle and a secondary outlet pipe.

In one embodiment, the secondary outlet pipe, in use, extends downwardly from the baffle towards a fluid body bed.

In one embodiment, the outlets includes a nozzle adapted to guide the second fluid along the baffle in a direction substantially parallel to the outer surface.

In one embodiment, the baffle is pivotally mounted to the platform thereby allowing an inclination of the baffle within the fluid body to be adjusted.

In one embodiment, the baffle is pivotally mounted to the platform proximate a first end of the baffle, the outlets being provided proximate a second opposing end of the baffle.

In one embodiment, the apparatus includes a locking mechanism to lock the baffle at a selected angle relative to the platform.

In one embodiment, the locking mechanism includes an adjustable support pillar extending between the baffle and the platform.

In one embodiment, the support pillar is pivotally attached to the baffle and selectively engages the platform to thereby allow the angle of the baffle relative to the platform to be adjusted.

In one embodiment, the support pillar is arcuately shaped.

In one embodiment, the support pillar includes a plurality of teeth spaced along at least part of the support pillar, where the teeth engage the platform to thereby position the support pillar relative to the platform.

In one embodiment, the support pillar includes a plurality of openings spaced apart along a length of the support pillar, where the apparatus also includes a locking pin that is insertable into a locking pin socket on the platform and into a respective one of the openings to thereby lock the support pillar into a fixed position relative to the platform.

In one embodiment, the fluid body includes at least one of: water, an iced covered fluid body, suspended solids, a slurry, and a sludge.

In one embodiment, the second fluid includes at least one of: water, acids, air, suspended solids, semi-liquid materials, gels, other gases, and flocculants.

In another aspect of the present disclosure, an apparatus for controlling flow of fluid in a fluid body includes a platform that in use is provided on a surface of the fluid body. The platform includes at least one mooring connector that, in use, is coupled to a mooring to thereby at least partially restrain movement of the platform in use. A baffle is attached to the platform so that the baffle is at least partially submerged in the fluid body. The baffle may be pivotally mounted so that an angle of inclination of the baffle within the fluid body can be adjusted, thereby allowing the baffle to selectively deflect flow of material within the fluid body.

It will be appreciated that the features, aspects, and details of one or more implementations of the apparatus as disclosed herein can be used in conjunction, interchangeably and/or independently, and reference to separate examples and embodiments is not intended to be limiting.

### BRIEF DESCRIPTION OF THE DRAWINGS

Various examples and embodiments will now be described with reference to the accompanying drawings, in which:

FIG. 1A is a schematic side view of an example of an apparatus for controlling a flow of fluid within a fluid body;

FIG. 1B is a schematic front view of the apparatus of FIG. 1A;

FIG. 2A is a schematic side view of an example of a platform;

FIG. 2B is a schematic cross sectional view along the line A-A′ of FIG. 2A;

FIG. 2C is a schematic plan view of the platform of FIG. 2A;

FIG. 3A is a schematic underside view of a specific example of a baffle;

FIG. 3B is a schematic end view of the baffle of FIG. 3A;

FIG. 3C is a schematic plan view of the baffle of FIG. 3A;

FIG. 3D is a schematic side view of the baffle of FIG. 3A;

FIG. 3E is a schematic cross sectional view along the line B-B′ of FIG. 3A;

FIG. 3F is a schematic cross sectional view along the line B-B′ of FIG. 3A showing the use of a secondary outlet;

FIG. 4A is a schematic front view of a specific example of a support pillar;

FIG. 4B is a schematic side view of the support pillar of FIG. 4A;

FIG. 5A is a schematic perspective plan view an apparatus for agitating a fluid body including a platform of FIG. 2A, a baffle of FIG. 3A and support pillar of FIG. 4A;

FIG. 5B is a schematic side view of the apparatus of FIG. 5A with the baffle in a lowered position;

FIG. 5C is a schematic side view of the apparatus of FIG. 5A with the baffle in a partially raised position;

FIG. 6A is a schematic side view of a further example of an apparatus for controlling a flow of fluid within a fluid body; and

FIG. 6B is a schematic front view of the apparatus of FIG. 6A.

### DETAILED DESCRIPTION

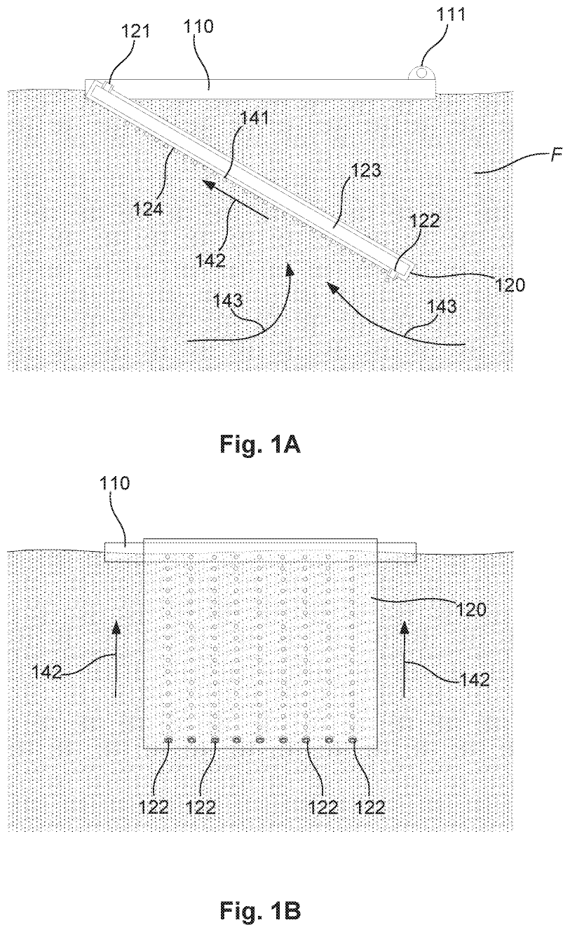

An example of apparatus for controlling flow of fluid in a fluid body will now be described with reference to FIGS. 1A and 1B.

For the purpose of this example, the fluid body is assumed to be a pool, lagoon, lake, pond, tank, reservoir or the like, containing a first fluid that requires agitation. The first fluid could be water, and could include one or more other components such as suspended solids, slurry, sludge or the like, but it will be appreciated from the following description that the technique is generally applicable to any fluid.

In this example the apparatus 100 includes a platform 110 that, in use, is provided on a surface of the fluid body F. The platform 110 may be at least partially buoyant and may incorporate ballast and/or buoyancy aids in order to provide a desired degree of buoyancy in use.

The platform 110 includes a mooring connector 111 which can be coupled to a mooring to thereby at least partially restrain movement of the platform in use. Alternatively, the mooring connector can be used to interconnect multiple platforms 110, allowing an array of platforms to be provided, as will be described in more detail below. The mooring connector 111 may be of any appropriate form and could include for example an eyelet, cleat, bollard, or the like, which is attached to a mooring line, such as a rope or chain, which can in turn be attached to a shore mounted mooring bollard, an anchor submersed in the fluid body, another platform, or the like, depending on the preferred implementation. It will therefore be appreciated that any suitable form of mooring mechanism can be used.

The apparatus further includes a baffle 120 that is attached to the platform, so that the baffle is at least partially submerged in the fluid body at an angle relative to the platform 110, such that the baffle may be inclined within the fluid body. The baffle 120 can be attached to the platform 110 at a fixed angle, but alternatively the baffle may be pivotally mounted, allowing the angle to be adjusted. In this example, the baffle 120 can be held at a desired inclination angle, for example using a locking mechanism, or could be left free over a range of angles, for example depending on currents within the fluid body. Alternatively, the baffle could include a differential or partial buoyancy, so that a free end of the baffle tends to sink to a defined operating depth.

The baffle 120 can be used in a passive manner to divert flow of fluid within the fluid body, such as preventing flow across part of the fluid body, optionally diverting flow towards the fluid body bed. For example, the apparatus could be provided near an inflow that contains suspended solids, with the baffle being used to deflect the inflowing fluid to remove energy from the flow and to assist with settling of solids, such as by reducing dispersal of solids throughout the fluid body.

Additionally and/or alternatively, the baffle 120 can be used in an active manner to induce movement within the fluid body. In this example, the baffle 120 includes an inlet 121, a number of outlets 122, and at least one internal channel 123 is provided within the baffle, extending from the inlet 121 to the outlet 122. In use, the inlet 121 is coupled to a fluid supply (not shown) that supplies a second fluid, so that the second fluid is transferred via the internal channel 123 to the outlets, allowing the second fluid to be expelled therefrom, as shown for example by the bubbles 141. The baffle 120 also includes an outer surface 124 that acts with the outlets 122 to at least partially guide the second fluid expelled from the outlets 122, so as to induce a flow of fluid within the fluid body, as shown by the arrow 143, and thereby induce flow and hence agitate the fluid body.

For example, if the second fluid is air or another gas, bubbles 141 form as the gas is expelled from the outlets 122, with the bubbles rising guided by the outer surface 124, as shown by the arrow 142. This, along with the angle of the baffle, will draw in surrounding first fluid, inducing flow as shown by arrows 143. However, it will also be appreciated that the outlets 122 can additionally be arranged to direct jets of second fluid at least partially parallel to the baffle outer surface 124, to induce or increase the degree of flow.

Accordingly, the above described arrangement provides a mechanism for inducing fluid flow within a fluid body. This is performed utilising a baffle 120 having an internal channel 123 allowing a second fluid to be supplied from an inlet 121, which can be provided above or substantially near a surface of the fluid body, to an outlet 122 provided at depth within the fluid body, with the depth being controlled based on an angle of inclination of the baffle 120. Additionally, the baffle 120 can act to provide a guide surface 124 guiding flow of fluids allowing this to be used to introduce directional fluid flow within the fluid body, which can in turn be used to agitate the fluid body, such as to aerate and/or otherwise disturb the fluid body.

This simple construction avoids the need for a complex arrangement, such as the use of multiple diffusion members for aeration, whilst also allowing flow to be created. This in turn reduces costs and chances of equipment failure. The baffle can be manufactured from fluid and environment tolerant materials, such as plastics, meaning this has a long life and avoids issues of corrosion.

Additionally, the system can be implemented with a wide range of different fluids and fluid supplies. For example, the system can use a shore mounted pump, attached to the inlet via a connector pipe or tube, allowing a second fluid, such as water, air and one or more additives, to be pumped into the inlet 121, without requiring pump or blowing equipment to be installed on the apparatus itself. This separation of the pumping or blowing equipment can help reduce maintenance requirements, and allow the equipment to be interchanged more easily if required.

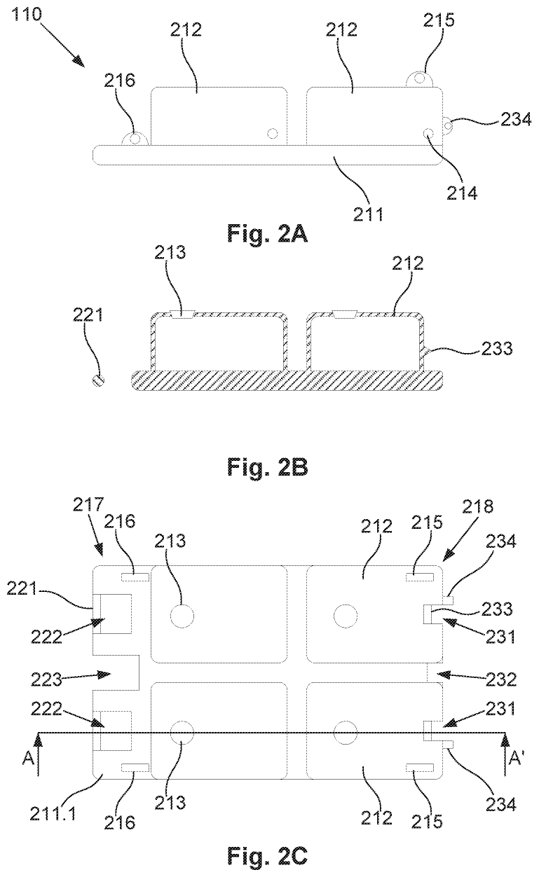

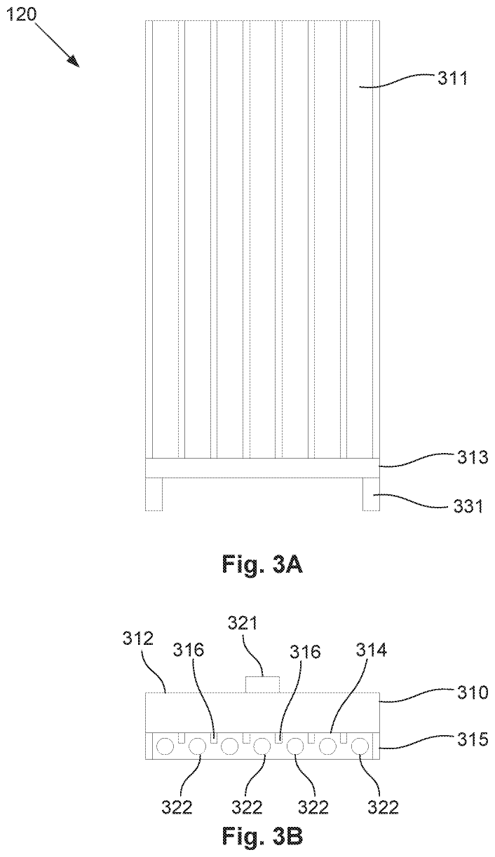

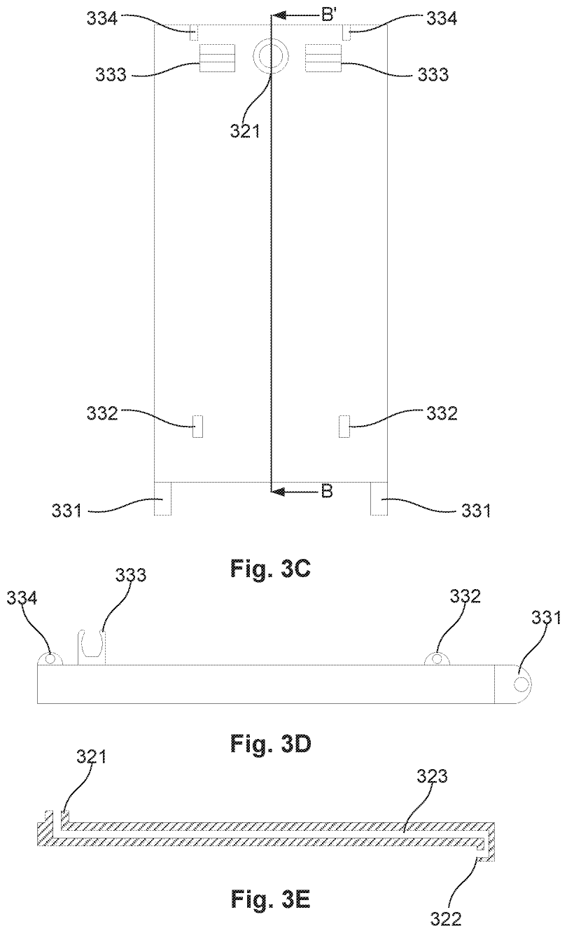

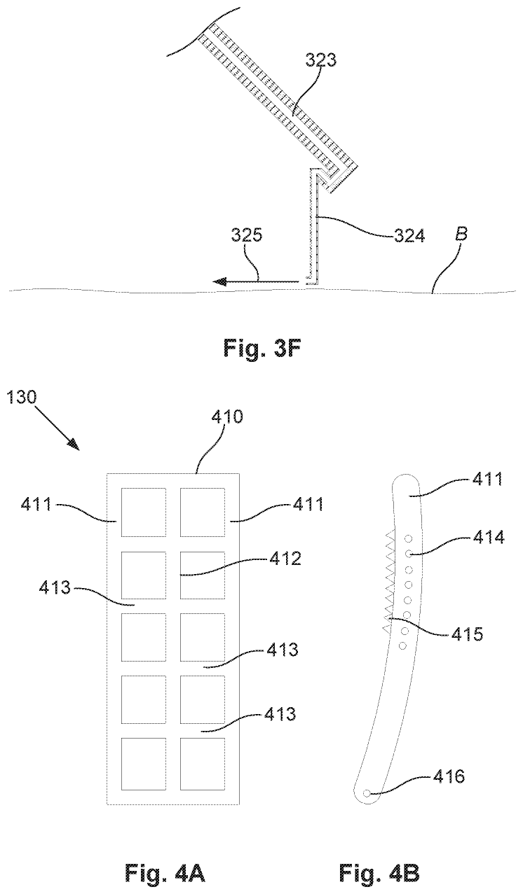

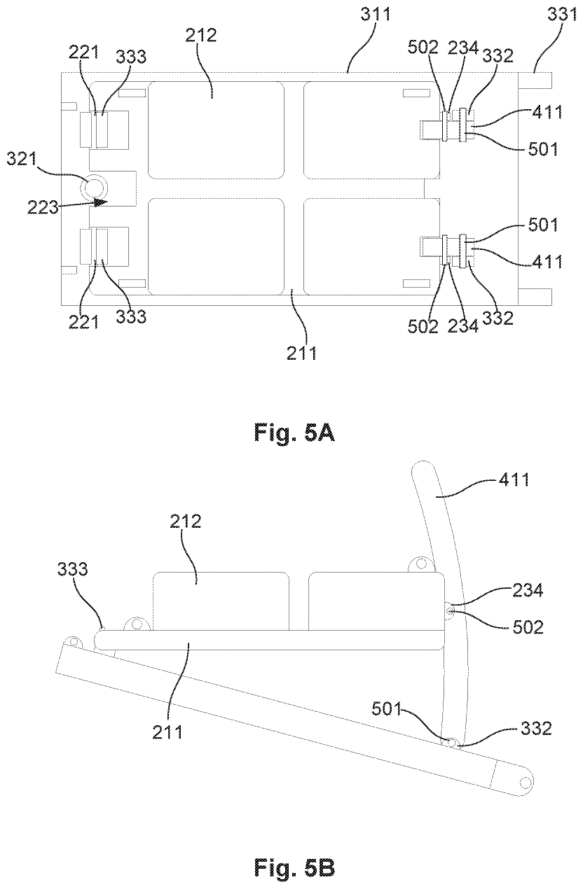

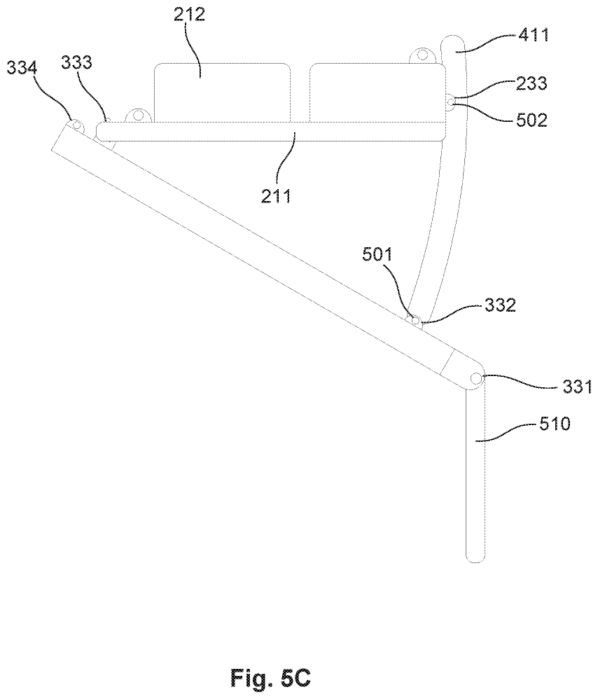

A number of further features will now be described with reference to an example that includes a platform, as shown in FIGS. 2A to 2C, a baffle, as shown in FIGS. 3A to 3F, and a support pillar, as shown in FIGS. 4A and 4B, with the resulting overall exemplary apparatus being shown in FIGS. 5A to 5C.

As shown in FIGS. 2A to 2C, the platform 110 includes a platform body 211 having a number of ballast tanks 212 mounted thereon. In this example, the platform body 211 is substantially rectangular, with four cuboid ballast tanks 212 provided on an upper surface of the platform body 211, with the platform 211 including an end portion 211.1 extending beyond the ballast tanks 212 at a first end 217 (referred to as a front end for illustration). Multiple ballast tanks can be used to ensure that ballast is evenly distributed over the platform, and in particular to prevent ballast flowing to one corner of the platform in the event that the platform tips over in use, whilst also allowing ballast to be selectively distributed to account for uneven weight distribution on the platform, leading to improved stability.

It will be appreciated, however, that this is not essential and in general any shape and arrangement of platform body 211 and tanks 212 could be used. In one example, the platform body 211 and ballast tanks 212 are integrally formed from a suitable polymer, for example through Rotational Molding (BrE moulding), although any suitable manufacturing technique could be used. The platforms can also be profiled to allow platforms to be stacked for ease of transport and storage.

Each ballast tank 212 may include an inlet 213 on an upper surface and an outlet 214 provided in a lower part of a side wall, allowing a ballast material, such as water, to be added to and removed from the ballast tank as required. This can be used to adjust the buoyancy of the platform, and selectively control the buoyancy, for example to make a front or rear more or less buoyant, which can be used to help the platform remain substantially level in use. The inlets 213 and outlets 214 may be sealed using a removable rubber or plastic threaded plug or valve or similar in use.

The platform further includes a number of mooring connectors 215, 216, which in this example are eyelets mounted on upper sides of 212 ballast tanks towards a second end 218 (referred to as a rear end for illustration) of the platform and on the end portion 211.1, allowing the platform 110 to be secured to a mooring at either the front or rear ends 217, 218 of the platform, as well as to allow adjacent platforms in an array to be interconnected at both a front and rear of the platform. When provided in an array, upper surface of the ballast tanks can be used to define a walkway, in which case additional features such as railings or the like might be incorporated into or attached to the structure as needed, depending on the preferred implementation.

Provision of mooring connectors 251, 216 near a front and rear of the platform can be used to allow a position of the platform within the fluid body to be adjusted. For example, if the mooring connectors are coupled via respective mooring lines to separate winches, operation of the winches can be used to move the platform within the fluid body, including moving the platform, laterally or longitudinally, as well as rotating the platform if required. It will also be appreciated that similar movements could also be performed manually, and reference to winch powered operation is not intended to be restrictive.

The platform 110 further includes a baffle mounting proximate at a front end 217 of the platform, the baffle mounting being adapted to pivotally support the baffle 120. In this example, the platform mounting is formed from first and second laterally spaced rectangular cut-outs 222 provided in a leading edge of the end portion 211.1, with each cut-out 222 being bridged by a tubular strut 221, which acts to define a pivotal mounting for the baffle 120, as will be described in more detail below. It will be appreciated, however, that other suitable arrangements could be used.

The end portion 211.1 can also include a further centrally located cut-out in a leading edge, the cut-out being provided to accommodate a baffle inlet, as will be described in more detail below.

A rear surface of the rear ballast tanks 212 and a rear edge of the platform 211, between rear ballast tanks 212, include rectangular cut-outs defining upright laterally spaced side and central pillar channels 231, 232, which in use receive a support pillar. The side pillar channels 231 include a laterally extending tooth 233, whilst a locking pin socket 234 is mounted to a rear surface of the ballast tanks 212, adjacent each laterally spaced channel 231, to assist with locking the support pillar in position.

As shown in FIGS. 3A to 3F, the baffle 120 is formed from an at least partially hollow body 310, having a substantially planar upper surface 312 spaced apart from a substantially parallel lower outer surface 311 to define an internal channel 323 extending from an inlet 321, arranged proximate a first (forward) end of the upper surface 312 to a plurality of laterally spaced outlets 322 provided proximate a second (rear) end in the lower outer surface 311. In this example, the baffle 120 has a generally elongate rectangular cuboid shape and can be manufactured from a suitable material, such as a rotationally moulded plastic material, although this is not essential and any suitable arrangement could be used. Again, baffles may be profiled to allow baffles to be stacked to assist with transport and storage.

In this example, the baffle 120 includes an end wall 313 extending perpendicularly from the lower outer surface 311 proximate the rear end, with the outlets 322 being provided in the end wall 313 so that the outlets face in a direction substantially parallel to the outer surface 311, thereby guiding fluid flow along the outer surface 311.

The outer surface 311 may be profiled to define one or more external channels 314 to assist in directing flow of fluid at least part way along a length of the baffle. In this example, the channels 314 are defined by outer downwardly extending side walls 315 and a plurality of spaced apart ridges 316, running substantially along a length of the outer surface 311. It will be appreciated that, alternatively, other configurations could be used to define the channels, such as a scalloped shaping of the baffle surface 311, or the like. In use, the channels assist in guiding the flow of fluid along the underside of the baffle, which can in turn maximise the effectiveness of the flow.

For example, when used actively for aeration, this can assist in causing merging of bubbles of gaseous second fluid, forming larger bubbles, which can more effectively drive movement of the fluid within the fluid body. Alternatively, when used passively to divert a fluid flow, this can be used to ensure incoming flow passes along a length of the baffle surface, guiding this towards a fluid body bed, and removing more energy than if the flow passes around the baffle.

The channels can include features to control fluid flow along the channels, for example to control a flow rate. This can include the presence of shapes, profiles, or surface textures, including but not limited to fluting, rifling, scalloping, or the like, although it will be appreciated that other features, such as changes in orientation of the channel could be used. In one example, different channels can include different features to thereby introduce differential flow rates along the channels, which in turn can control a residence time of the upward or downward movement of the fluids (gases or liquids) along the channels. This can facilitate mixing with the fluid, for example, ensuring a solid or gel is fully dissolved within the water in the reservoir.

The outlets 322 may be aligned with the external channels 314, allowing fluid flow from the outlets 322 to be guided along each of the external channels 314, thereby leading to even movement of fluid over substantially the entire outer surface 311 of the baffle 120. This, in turn, can assist in generating currents of movement within the fluid body leading to large scale fluid flow.

The outlets 322 can include simple openings and may include an embedded connector, which can in turn receive a number of different outlet fittings, such as nozzles, or the like. Such a connector could be of any appropriate form, such as an interference or threaded connector. In one example, as shown in FIG. 3F, a secondary outlet pipe 324 can be fitted to one or more of the outlets 322 to allow fluid to be emitted remotely from the baffle 320. For example, the secondary outlet pipe 324 can be adapted to extend downwardly from the baffle 320 towards a fluid body bed B, allowing this to be used to urge fluid directly into or along a line of the bed B, as shown by arrow 325, to assist in agitating the fluid bed. Additionally, it will be appreciated that gaseous fluids delivered by the secondary outlet pipes 324 will tend to rise and impact on the underside of the baffle, being guided to flow along an underside of the baffle 120, and optionally merge with fluid emitted from the outlets 322.

The internal channel 323 within the baffle 120 can be of any appropriate shape, and could extend between the upper and lower surfaces 311, 312 and/or extend along the side walls 315. The internal chamber can also include internal features, such as tortuosities, baffles or the like, to assist with internal mixing. For example, in the event that two fluids are supplied to the inlet, the internal features can assist with mixing of the fluids, thereby ensuring these are sufficiently mixed prior to delivery to the outlets 322.

The baffle 120 may include laterally spaced platform mountings 333 provided proximate the front end of the upper surface 312, allowing the baffle to be pivotally mounted to the platform 110, so that an inclination of the baffle 120 within the fluid body can be adjusted. Adjusting the inclination of the baffle 120 can assist controlling fluid flow within the fluid body. For example, this can be used to adjust whether flow is largely confined to a surface of the fluid body, or extends to deep within the fluid body, drawing fluid up from a fluid body bed.

In this example, the platform mountings 333 include spaced apart arms defining a lateral opening that can clip onto the tubular strut 221, although it will be appreciated that other coupling mechanisms could be additionally or alternatively used, such as using a fastener arrangement, such as a locking pin or bolt extending through the spaced apart arms to secure the platform mountings 333 to the baffle. Additionally, it will be appreciated that other arrangements for pivotally mounting the baffle 120 to the platform 110 could be used.

The baffle 120 can also include laterally spaced mooring connectors 334, such as eyelets, cleats, or the like, mounted proximate the front end of the upper surface 312, to assist with attaching the apparatus to a mooring or to other baffles in an array.

The baffle 120 may include baffle connectors 331, extending from rear corners of the baffle body, allowing a secondary baffle to be supported from the lower end of the baffle, such as shown in FIG. 5C. The secondary baffle can be used to support a secondary outlet pipe 324, and or the assist in guiding formation of currents within the fluid body.

In one example, the apparatus includes a locking mechanism to lock the baffle 120 at a selected angle relative to the platform 110. The locking mechanism could be associated with the pivotal mounting, for example restricting movement of the pivotal mounting to thereby lock the baffle 120 in position. However, the locking mechanism may include an adjustable support pillar extending between the baffle 120 and the platform 110, with the support pillar being pivotally attached to the baffle 120 and able to selectively engage the platform 110 to thereby allow the angle of the baffle 120 relative to the platform 110 to be adjusted.

To achieve this, in one example, the baffle 120 includes laterally spaced support pillar mountings 332 provided on the upper surface 312 part way in from the rear edge of the baffle body, allowing a support pillar to be pivotally mounted thereto.

An example support pillar will now be described with reference to FIGS. 4A and 4B.

In this example, the support pillar 410 includes a central elongate support beam 412 and first and second laterally spaced elongate side support beams 411 spaced apart from the central support beam and attached to the central support beam via lateral ribs 412, to form a grid-like structure. The central and side support beams 412, 411 are spaced apart to align with the side and central pillar channels 231, 232 of the platform, as will be described in more detail below. The pillar can be manufactured from a plastic material, for example using rotational moulding, and is generally configured to be stackable to assist with storage and transport. The pillar can also be hollow to reduce weight, and in one example can include openings (not shown) allowing the pillar to fill with fluid upon submersion in the fluid body, thereby avoiding the pillar adversely affecting the overall buoyancy of the apparatus.

The central and side beams 412, 411 are generally curved to define an arcuate shape, as shown in FIG. 4B, to facilitate engagement with the platform through a range of different baffle angles. A plurality of pillar teeth 415 are provided extending along part of an inner face of the side support beams 411, with a plurality of lateral fastener openings 414 extending through the side beams, being spaced apart along part of the length of the side beams 411, which are used to secure the support pillar to the platform 110. Finally, a baffle mounting, including a baffle fastener opening 416 is provided in a lower end of the side beams 411, allowing the support pillar to be attached to the baffle 120.

An example of the apparatus in a constructed operational state will now be described with reference to FIGS. 5A to 5C.

In this example, the baffle 120 is coupled to the platform 110, by having the arms of the platform mountings 333 clip into engagement with the tubular struts 221 so that front ends of the platform 110 and baffle 120 are pivotally connected. In this configuration, the inlet 321 sits within the central cut-out 223, allowing a fluid supply tube (not shown) to be attached to the inlet 321.

The support pillar 410 is then coupled to the baffle 120, by having a fastener, such as a bolt or pin extend through the baffle fastener opening 416 and the spaced support pillar mountings 332, thereby pivotally mounting the support pillar 410 to the baffle 120.

The side and central beams 411, 412 of the support pillar are then positioned in the side and central channels 231, 232 of the platform 110, so that the pillar teeth 415 engage the tooth 233 within the side pillar channels 231, thereby positioning the support pillar 410, so that the baffle 120 is provided at a desired angle relative to the 110. A locking pin 502 can then be inserted through the locking pin socket 234 and one of the fastener openings 414 to thereby secure the support pillar 410 to the platform 110. In one example, the locking pin 502 can be retractably mounted in the locking pin socket 234, to facilitate engagement with the fastener openings 414.

Accordingly, it will be appreciated that this allows the baffle 120 to be connected to the platform 110 at a desired angle, and held in position using the support pillar 410, as shown for example in FIGS. 5B and 5C. Additionally, secondary baffles 510 can be provided mounted to the baffle connectors 331, allowing additional control over the flow of fluid in the fluid body. In particular, the secondary baffles can be used to provide a curtain for assisting diverting currents. The secondary baffles can be made of one or more of a woven or unwoven fabric, plastic, netting, rubber, a permeable or semi permeable membrane, plastic or the like. The secondary baffle can also be used to provide support to a secondary outlet pipe 324.

Once configured, the apparatus can be deployed by placing this in the body of fluid, and attaching one or more mooring lines to the mooring connectors, to move the apparatus to and then hold the apparatus in a desired position, and with ballast being added to the ballast tanks 212 as required. In this regard, the ballast requirements will depend on factors such as the nature and pressure of the fluid being delivered, the angle of the baffle 120 or the like. For example, if the second fluid is air, this will mean the baffle is substantially air filled in use, and hence will be very buoyant, meaning the ballast tanks 212 may need to be full and/or nearly full of ballast, whereas if the second fluid is water, minimal ballast may be required. Additionally, if the second fluid is delivered under high pressure, this will cause a downward jetting force as fluid is emitted from the outlets 322, meaning a reduced level of ballast may be required.

Multiple platforms 110 can be interconnected via the mooring lines, allowing an array of platforms 110 and baffles 120 to be created. Such an array can use multiple baffles provided at the same of different angles of inclination, in order to create desired flow within a large body of water.

Once positioned, second fluid can delivered from a supply to the inlet 321 via a supply tube. The nature of the second fluid will vary depending on the particular circumstances. For example, this could include water if the primary purpose is mere agitation of the fluid body, but could include air if greater aeration is required. Additionally, further additives can be additionally or alternatively used, such as flocculants, treatment chemicals, such as chlorine, acids or stabilisers, suspended solids, semi-liquid materials, gels, or the like, which can be used to change properties of the first fluid. For example, this can be used to assist in settling of solids within the fluid body, disinfecting the first fluid, or the like.

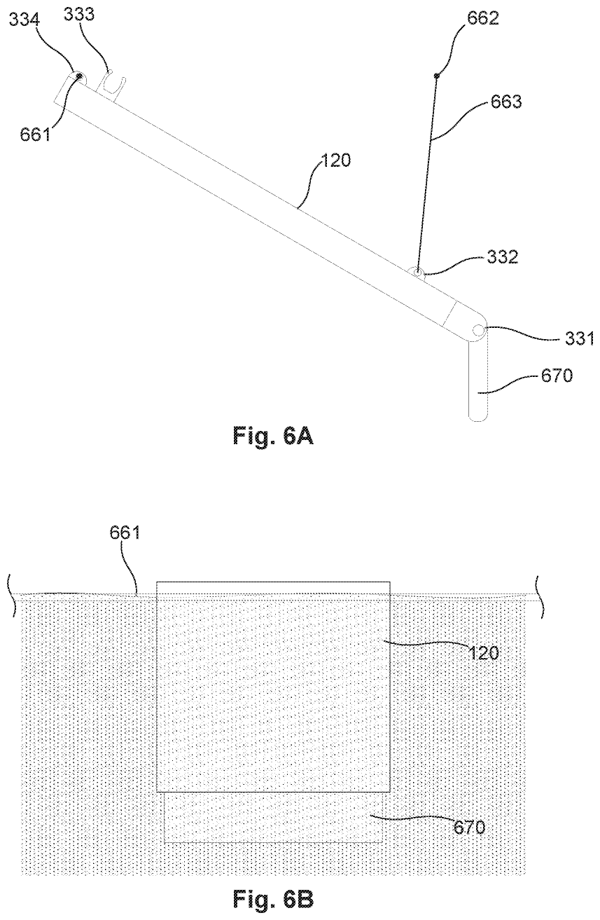

An alternative example apparatus will now be described with reference to FIGS. 6A and 6B.

In this example, the apparatus includes a baffle 120 generally similar to the baffle described above with respect to FIGS. 3A to 3F, and features of this will not therefore be described in further detail.

In this example, instead of being attached to a platform, the baffle can be secured in the fluid body using a securing member, such as a mooring rope 661, which is coupled to a mooring to thereby at least partially restrain movement of the baffle in use. In this example, the mooring rope 661 passes through the mooring connectors 334 although other suitable connections could be used.

In this example, the baffle can have a negative buoyancy so that the baffle is at least partially submerged in the fluid reservoir. The negative buoyancy can result from the construction of the baffle, for example by manufacturing the baffle from a negatively buoyant material, or may arise through the use of ballast, either contained internally within the baffle, or connected to the baffle, for example as part of secondary baffles 670, or connected to external baffle connectors 331. Such ballast could include sand, gravel, concrete, metal, or the like.

The baffle can be provided at any orientation within the fluid body, and could be provided vertically, to thereby act as an under fluid retaining fence structure, to thereby constrain movement of fluid and/or other contents within the fluid body. Alternatively, the baffle could be angled, for example by attaching ballast offset from a center of the baffle, so that differential buoyancy maintains a desired angle.

Additionally and/or alternatively, a first end of the baffle is attached to a first mooring connector 661 and a second end of the baffle is suspended from a surface body 662, such as a float or second mooring connector, for example using a rope, chain, or other securing member 663 attached to the support pillar mountings 332, allowing an angle of the baffle to be adjusted based on a length of the securing member.

Accordingly, the above described arrangement provides a simple apparatus that can be used actively for aeration and/or to meet other requirements for generating flow. It will also be appreciated that the apparatus can also or alternatively be used passively to provide a barrier to divert, deflect, control, and/or reduce flow as required, which can assist in settling of solids within the fluid body.

In one example, the system includes a three piece construction, which can be easily assembled simply by attaching the baffle and platform, attaching the support pillar to the baffle and then the platform, once the baffle has been provided in a desired orientation. This is feasible largely due to the simple one piece construction of the baffle, including the integrated internal channel to deliver fluid from an inlet to multiple outlets that are positioned within the fluid body by virtue of the inclination of the baffle relative to the platform.

As each of the components, and in particular the platform, baffle, and support pillar, can be constructed from lightweight moulded plastic materials, this makes it feasible for these to be manipulated by a single person, meaning the apparatus can be assembled and deployed by a single person. Furthermore, the plastic construction makes the apparatus extremely durable, enabling this to be used in adverse environments, and with a wide range of different fluids, without risk of corrosion.

In another example, the baffle can be used without the platform and support pillar, with the baffle being held in position using a mooring rope or other securing member, and the orientation of the baffle being controlled through one or more of negative buoyancy, positive buoyancy, suspension from a mooring rope or float, or the like.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. An apparatus for controlling flow of fluid in a fluid body containing a first fluid, the apparatus comprising:
a baffle configured to be at least partially submerged in the fluid body, the baffle comprising:
a) an inlet that, in use, is coupled to a fluid supply adapted to supply a second fluid;
b) at least one outlet;
c) at least one internal channel extending from the inlet to the at least one outlet to thereby allow the second fluid to be expelled from the at least one outlet; and,
d) an outer surface which acts with the at least one outlet to at least partially guide the second fluid expelled from the outlet to induce flow within the fluid body and thereby agitate the fluid body, wherein the outer surface includes one or more external channels for directing flow of fluid at least part way along a length of the baffle.

2. The apparatus of claim 1, wherein the apparatus includes a platform that, in use, is provided on a surface of the fluid body, the platform including at least one mooring connector that, in use, is coupled to a mooring to thereby at least partially restrain movement of the platform in use, and wherein the baffle is attached to the platform.

3. The apparatus of claim 2, wherein the platform includes at least one ballast tank, the ballast tank having an inlet and outlet in fluid communication with a ballast cavity to thereby allow ballast fluid to be added to or removed from the ballast tank to thereby adjust a buoyancy of the platform.

4. The apparatus of claim 2, wherein the platform includes a platform body including a baffle mounting proximate at a first end of the platform, the baffle mounting being adapted to pivotally support the baffle.

5. The apparatus of claim 1, wherein the baffle is attached to a mooring connector that, in use, is coupled to a mooring to thereby at least partially restrain movement of the baffle in use.

6. The apparatus of claim 1, wherein a first end of the baffle is attached to a first mooring connector and a second end of the baffle is suspended from a surface body using a securing member, allowing an angle of the baffle to be adjusted, based on a length of the securing member.

7. The apparatus of claim 1, wherein ballast is used to at least partially submerge the baffle, and wherein the ballast is at least one of attached to and provided in the baffle.

8. The apparatus of claim 1, wherein the baffle is made of an at least partially hollow body.

9. The apparatus of claim 1, wherein the one or more external channels are defined by a plurality of spaced apart ridges extending along at least part of a length of the outer surface.

10. The apparatus of claim 9, wherein at least one channel includes features to control fluid flow along the at least one channel, and wherein at least one of
a) the features include at least one of:
i) shapes;
ii) profiles;
iii) surface textures;
iv) fluting;
v) rifling; and,
vi) scalloping; and
b) different channels include different features to introduce differential flow rates along the channels.

11-12. (canceled)

13. The apparatus of claim 1, wherein the baffle includes a plurality of laterally spaced outlets.

14. The apparatus of claim 1, wherein outlets include an outlet connector adapted to receive at least one of:
a) a nozzle; and
b) a secondary outlet pipe.

15. The apparatus of claim 14, wherein, when in use, the secondary outlet pipe extends downwardly from the baffle towards a fluid body bed.

16. The apparatus of claim 1, wherein outlets includes a nozzle adapted to guide the second fluid along the baffle in a direction substantially parallel to the outer surface.

17. The apparatus of claim 1, wherein the baffle is pivotally mounted to a platform thereby allowing an inclination of the baffle within the fluid body to be adjusted.

18. The apparatus of claim 17, wherein the baffle is pivotally mounted to the platform proximate a first end of the baffle, the outlets being provided proximate a second opposing end of the baffle.

19. The apparatus of claim 17, wherein the apparatus includes a locking mechanism to lock the baffle at a selected angle relative to the platform.

20. The apparatus of claim 19, wherein the locking mechanism includes an adjustable support pillar extending between the baffle and the platform, and wherein the support pillar at least one of:
a) is pivotally attached to the baffle and selectively engages the platform to thereby allow the angle of the baffle relative to the platform to be adjusted;
b) is arcuately shaped;
c) includes a plurality of teeth spaced along at least pan of the support pillar, and wherein the teeth engage the platform to thereby position the support pillar relative to the platform; and
d) includes a plurality of openings spaced apart along a length of the support pillar and wherein the apparatus includes a locking pin insertable into a locking pin socket on the platform and into a respective one of the openings, to thereby lock the support pillar into a fixed position relative to the platform.

21-24. (canceled)

25. The apparatus of claim 1, wherein the fluid body includes at least one of:
a) water;
b) an iced covered fluid body;
c) suspended solids;
d) a slurry; and
e) a sludge.

26. The apparatus of claim 1, wherein the second fluid includes at least one of:
a) water;
b) acid;
c) air;
d) suspended solids;
e) semi-liquid materials;
f) gels;
g) other gases; and
h) flocculants.
